(19) United States
(12) Patent Application Publication
(10) Pub. No.: US 2005/0120002 A1
(43) Pub. Date: Jun. 2, 2005

(54) Automated text generation process

(76) Inventor: Hassan Behbehani, Kuwait (KW)

Correspondence Address: Hassan Behbehani, P.O. Box: 1262 Safat, Kuwait, 13013, KW

(21) Appl. No.: 10/939,353

(22) Filed: Sep. 14, 2004

Related U.S. Application Data
(60) Provisional application No. 60/507,518, filed on Oct. 2, 2003.

(51) Int. Cl. G06F 7/00

(52) U.S. Cl. 707/3

(57) ABSTRACT

The process of text generation/creation is automated. The text to be processed is used as seed for the text generation process. The text to be processed can be in any language and can be passed to text generation process through any internal/external application or process, through speech technology or through manual entry. At the first step, word(s) are extracted from the text. Each word is considered as seed and this seed is grown up into different word(s)/sentence(s) lists according to the selected criteria. The generated lists are then processed and combined/jointed through a simple mechanism to generate text. This generated text then can be saved, analyzed, filtered or searched on the internet, intranet, extranet, in database(s) or in user defined data repositories again according to the criteria selected by the user or by some external application or process.

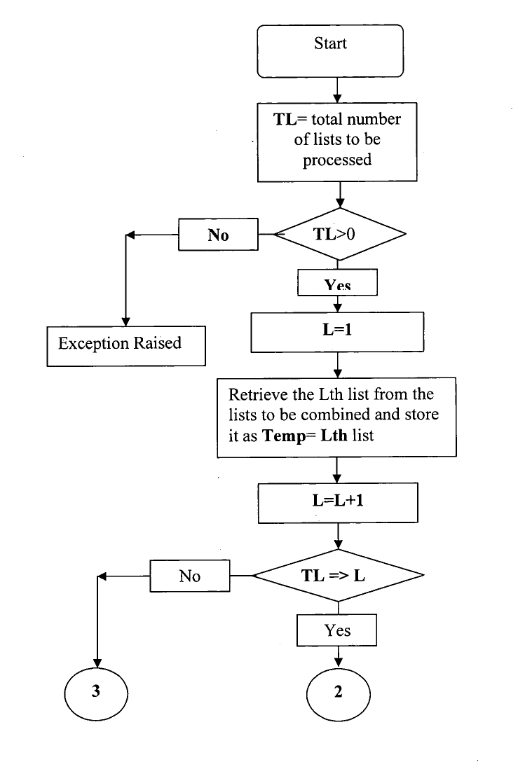

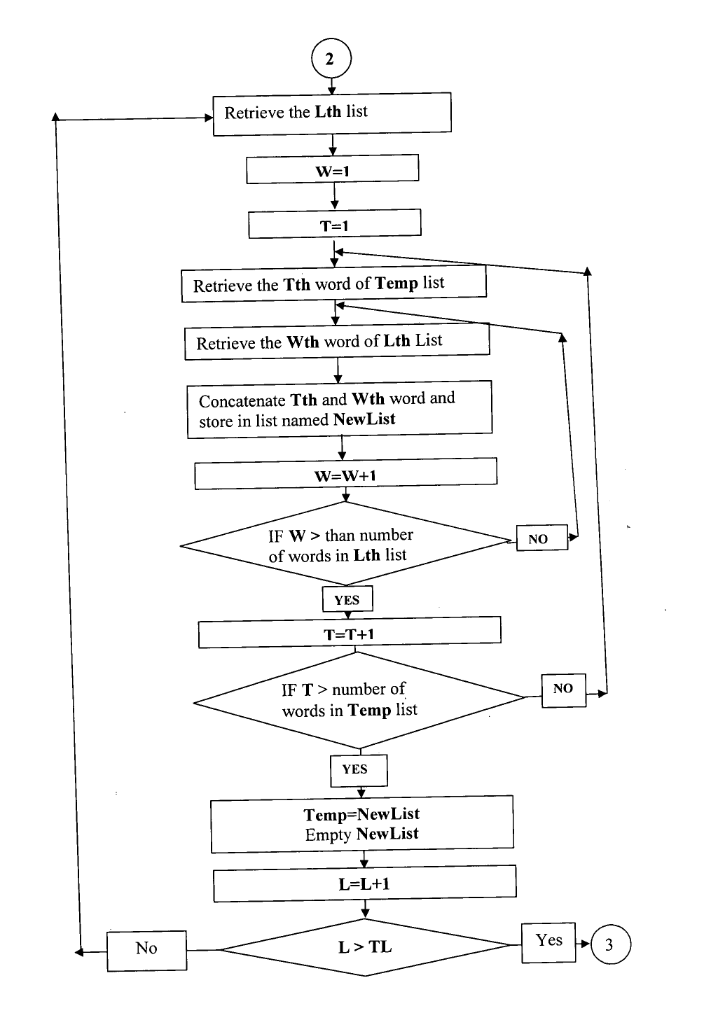

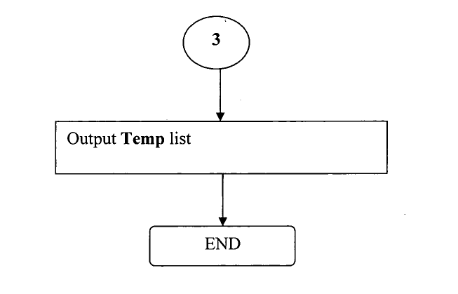

### BACKGROUND OF THE INVENTION

The present invention relates particularly to create text dynamically from a text according to different criteria. The input text and these criteria can be provided by user(s) or any internal/external application or process.

This information creation/collection and use is important both for individuals and corporate entities. This methodology is particularly useful but not limited to different entities such as search engines, Research Organizations, news agencies, Help Desks, Government organizations, Universities, colleges, and almost every entity where information seeking need is imminent. This process is helpful for entities that can be benefited by text and alternative texts in such as Publishing organizations, Writers, Authors, lecturers, teachers, Institutions to provide (customizable) textbooks and courseware according to students interests and details . . . etc. The presented invention is also helpful for USPTO employees, USPTO′ customers and users for prior or related art or information searching at USPTO.

The said methodology can be used in automated and manual ways. Both ways are useful. For example, automated methodology can generate thousands of sentences with one click; its too fast and much optimized as said methodology automatically identify the duplicate words and sentences and can remove these duplicates as well. Whereas manual method of sentence generation help the users if they want to be limited and to specific options.

The said methodology can help the users in brain storming. In many brain storming tools, its common to present the users with different words for inspiration. But these words oftenly are not specifically related with the user problem. These tools just create random words, whereas said methodology helps the users to concentrate on specific area and can present users words related with their problem in order to solve their problems in creative way with less time.

The methodology presented here may also be used to create different scenarios about a particular situation. For example, a user has land and wants to use it for some business purpose. The user may have different options such as make hospital and sale it, make building and rent it and so. The methodology is usefull in creating such options and presents the user with all the options before him at once. This thing not only increases the scope and vision of user about a particular situation but provides helping hand in foreseeing, concentration and identifying more ways to tackle a particular situation. For instance, consider these simple options as simple example: the words in brackets ( ) are list headers and are not counted for text generation.

| (Build) | (To) | (Client) |
|---|---|---|
| School | To rent | for local client |
| Hospital | To sale | For foreign client |
| Hotel | | |

When the sentences are combined through said methodology, 12 (3×2×2=12) sentences are generated as shown below.
1. School to rent for local client
2. School to rent for foreign client
3. School to sale for local client
4. School to sale for foreign client
5. Hospital to rent for local client
6. Hospital to rent for foreign client
7. Hospital to sale for local client
8. Hospital to sale for foreign client
9. Hotel to rent for local client
10. Hotel to rent for foreign client
11. Hotel to sale for local client
12. Hotel to sale for foreign client

The presented methodology can be used for creative purposes in many areas. The said methodology is also useful scientific and artistic research and creative activities . . . Etc. For example; in medical research doctors can use the said methodology to combine the medicines, diseases and symptoms. Later through this methodology can be used to effectively track specific information regarding medicines, diseases or symptoms. The said methodology can be used by writers to organize elements of scenarios according to publication principles in order to get inspiration, Consider below as another simple example: the words in brackets ( ) are list headers and are not counted for text generation.

| (Reason) | (Of) | (Illness) |
|---|---|---|
| Drugs | can cause | Cardiac diseases |
| Alcohol | | Cancers |
| Smoking | | Respiratory Problems |

These lists when combined, following 9 (3×1×3=9) sentences are generated.
1. Drugs can cause cardiac diseases
2. Drugs can cause cancers
3. Drugs can cause respiratory problems
4. Alcohol can cause cardiac diseases
5. Alcohol can cause cancers
6. Alcohol can cause respiratory problems
7. Smoking can cause cardiac diseases
8. Smoking can cause cancers
9. Smoking can cause respiratory problems

The said methodology does not work only for words. This can also generate results in case of numbers, chemical formulae and expressions . . . etc. Anyway said methodology can be used for any useful text.

The above presented examples are just simple and can be done manually. To present the invention usefulness, consider a scenario of research firm in need of data about companies selling medical equipment. The firm wants to sure that when they conduct search on internet, they don't skip any company. By using the said methodology, research firm can generate sentences in order to fulfill their requirements as shown below. The words in brackets ( ) are list headers and are not counted for text generation.

| (Companies) | (Selling) | (Medical) | (Equipment) |
|---|---|---|---|
| Companies | Selling | Medical | Equipment |
| Corporations | Trading | Medical Checkup | Tools |
| Parties | Auctioning | Medicinal | Utensils |
| Groups | Providing | Therapeutic | Apparatus |
| Vendors | Manufacturing | Curative | Devices |
| Dealers | Producing | Health | Kits |
| Sellers | Making | | Machinery |
| Merchants | Creating | | |
| Retailers | Inventing | | |
| Traders | Giving | | |
| Supplsiers | Offering | | |
| Firms | Supplying | | |

If above lists are combine, then there would be 6048(12 ×12×6×7=6048) sentences which off course manually requires lot of time. Also there would be less chances of skipping companies when these sentences are searched on web than using the single sentence. The example above also indicates how the possible scenarios may be enlisted about a certain situation and how possibilities can be indexed. The above example also shows how the said methodology can be effectively used in work and in business as well.

In more recent years, the use of computers has greatly increased the efficiency of data collection, data management and information seeking methodologies. Now there are lot of search engines and Meta search engines to deliver the users with their required information across the globe. But still lots of things are needed to be done especially regarding the search results quality and accuracy.

The search results returned by the most of the search engines are in so much quantity that makes it very difficult to the user to target their required information. Also the search results returned does not assist the users in information seeking. Mostly are returning what is typed by the user. For example user is looking for information for “Heart Diseases”. It might be that the information required by the user is at “cardinal Diseases” so the chances are very high that user may not find the required information or the information seeking may take lot of time.

Anyhow Google (famous Search Engine) has come ahead by providing the Synonyms Operator but still this technique is not quite efficient. To-date search engines and search methodologies available in the market have some obvious disadvantages such as
They do not assist the users “For what actually users are looking for?
Their search results view is not of much clarity
Third search engines available in market do not provide users the facility to logically group their information.
Search Engines and search methodologies do not provide the user to divide major information set into smaller information set. For example the term “Universities in US” may not return all the universities in each US state and may skip some states if meta-tags of those pages are missing the word “US”.

The invention presented here not only solves the above common problems with search engines and search methodologies it also makes it easier to search custom repositories such as documents and databases. The web pages are usually used to contain words and their relative words in someway but business applications and documents do no bear extra information in them. This invention presented here is also a great help to for the users who want to search some repositories which are not in their native languages.

### BRIEF SUMMARY OF THE INVENTION

In accordance with a preferred embodiment of the present invention, the process of generating text is automated. The text to be processed can be in any language, of any length, and can be passed to text generation process through any internal/external application or process, orally, through speech technology and/or through manual entry. First the words are extracted from inputted text. Each word is used to generate a list of words/text according to selected criteria. The generated lists are positioned at their corresponding words. At the final stage text are generated by combining these generated lists according to the selected criteria.

The generated text now can be filtered, analyzed and saved. The saved text can be retrieved and modified later. The generated text can also be modified and can be searched on internet, intranet, extranet or at custom repositories in form of group are on individual sentence basis defined by the user or by some external/internal application or process.

### BRIEF DESCRIPTION OF THE DRAWINGS

There are three drawings comprising the working of text generation process. This is the flowchart of core idea of “Automated Text Generation Process” spanning over three drawings. All the symbols used are the standard symbols used in flowcharts.

Sheet 1: Initialization/preparation of text generation process

Sheet 2: Inner working of process

Sheet 3: Output of text generation process

### DETAILED DESCRIPTION OF THE INVENTION

As this is called Information Age so lot of developments and researches are going to assist the users in finding/targeting their required information. There are search engines, Meta search engines and other desktop softwares to help users in information seeking.

As discussed invented text generation process may be helpful for not corporate entities but for individuals as well. Here is the process of our invented methodology.

Linguistically a sentence is defined as “A grammatical unit that is syntactically independent and has a subject that is expressed or, as in imperative text, understood and a predicate that contains at least one finite verb” Our invented methodology automatically generates text based on inputted text.

Our invented process take word(s)/text/series of word(s)/series of characters as input. The inputted text can be in any language, of any length, and can be passed to text generation process through any internal/external application or process, through speech technology, orally, and/or through manual entry. The inputted text then is used to generate text according to the criteria. When text is send to this process following steps are performed.

First Word(s) are Extracted from Text.

The inputted text is filtered to remove invalid entries if required. Words are extracted from the text that is being in process. For example consider the text “Word1 Word2 Word3 . . . WordN”. This text has the following words as shown in table 1. below:

Table 1 shows Words extracted from Text “Word1 Word2 Word3 . . . WordN”

TABLE 1
Table 1 has two columns named as Position and Word. The brackets ()
shows the column headers.

| (Position) | (Word) |
|---|---|
| 1 | Word1 |
| 2 | Word2 |
| 3 | Word3 |
| . | . |
| . | . |
| . | . |
| N | WordN |

Now the above sentence can also be defined as “1 2 3 . . . N”

After extraction of words next step is to create a words/text list for each word according to criteria attached with each word. Here are the lists of criteria that can be attached to word.

Synonyms: If this criterion is applied, it brings the synonyms from database or dictionary. Stemming is used in the criteria

Antonyms: If this criterion is applied, it brings the Antonyms from database or dictionary. Stemming is used in the criteria

Related Words: If this criterion is applied, it brings the related word(s) from database or dictionary. Stemming is used in the criteria

Word Suggestions: automatically set if word is not found in repository such as dictionary, file, document or database)

Custom Lists: These are statically lists attached with the word and are saved into database or Text File.

Summing Up Custom Lists: This facility allows to create alias fro multiple lists. When alias is accessed, all the lists which are attached with this alias are created in the same sequence as lists appear in alias.

Like custom lists, alias are created. After creation, all the custom lists are displayed offering users to attach these lists with particular alias. For example consider the custom lists of countries having names as regions such as Africa—Sub-Saharan, East Asia & the Pacific, Europe & Central Asia, Latin America & Caribbean, Middle East & North Africa and South Asia. If user wants to enlist all the entries in above regions then an alias can be created. In this case, for example, alias “International” can be created and attaching all the required regions with this alias. When International will be accessed, all the entries from attached lists are brought in front.

Custom Criteria

Here is tabular view of mechanism of attaching criteria with word. For example suppose following are the criteria attached with word(s). The words in brackets ( ) represent column headers of data in tabular format, below which each line represent the rows of data.

| (Word Position) | (Word) | (Criteria) |
|---|---|---|
| 1 | Word1 | CR1 |
| 2 | Word2 | CR2 |
| 3 | Word3 | CR3 |
| . | . | . |
| . | . | . |
| . | . | . |
| N | WordN | CRN |

Now all the preconditions for text generation process are completed. At the first stage, a list is generated for each word according to tagged criteria with that word. Each list is comprised/collection of word(s)/sentence(s)/word(s) or letter(s). First word from sentence currently under process is picked, corresponding criteria is applied and according to criteria, a list/collection is generated. Similarly second word(Word2) is picked, criteria is applied and corresponding list is generated. This is repeated until all the words in the sentence under process are analyzed and their corresponding lists are generated.

For example, when word “Word1” is processed then its corresponding criteria “CR1” is applied on it. Suppose it generates a list/collection named “WordL1” and the members of this collection are “Word11 Word12 Word13 . . . Word1N”. For example, similarly list/collection of “Word2” named “WordL2” is “Word21 Word22 Word23 . . . Word2N” and list for “WordN” named “WordLN” is “WordN1 WordN2 WordN3 . . . WordNN” Here is tabular view of generated lists.

Below are the Lists generated according to corresponding criteria

List for word “Word1”. The name of this list is “WordL1”. The word in brackets ( ) is list header and is not part of list.

(WordL1)
Word11
Word12
Word13
.
.
.
Word1N

List for word “Word2”. The name of this list is “WordL2” The word in brackets ( ) is list header and is not part of list.

(WordL2)
Word21
Word22
Word23
.
.
.
Word2N

List for word “Word3”. The name of this list is “WordL3” The word in brackets ( ) is list header and is not part of list.

(WordL3)
Word31
Word32
Word33
.
.
.
Word3N

List for word “WordN”. The name of this list is “WordLN” The word in brackets ( ) is list header and is not part of list.

(WordLN)
WordN1
WordN2
WordN3
.
.
.
WordNN

The lists generated in the above lists can be allowed to narrow by removing the words that are not required or can grow by appending further entries. As soon as generation of lists is completed, these lists are again presented to the user for reconsideration/review. Any of the lists generated in above sentence can be regenerated/redefined, expanded or narrowed or the whole process can be restarted. These lists are again tagged with the word for which this list is generated. This is similar like tagging criteria with the each word. Each list is tagged with the corresponding word. Here is tabular view of this mechanism. The words in brackets ( ) are column headers and are not part of data in rows:

| (Word Position) | (Word) | (Criteria) | (Generated List) |
|---|---|---|---|
| 1 | Word1 | CR1 | WordL1 |
| 2 | Word2 | CR2 | WordL2 |
| 3 | Word3 | CR3 | WordL3 |
| . | . | . | . |
| . | . | . | . |
| . | . | . | . |
| N | WordN | CRN | WordLN |

From the above discussion as we know our sentence under process is “1 2 3 . . . N”

Now text generation process puts the corresponding Lists at the word position so our original text becomes like “WordL1 WordL2 WordL3 . . . WordLN” where WordL1, WordL2, WordL3 and WordLN are the lists that have already been generated.

Completion of tagging “generated lists” triggers the process of combining the lists. First element is taken from the firs list and is combined with the first element of second list. The first element of the first list is again combined with the second element of second list. This process is continued until first element is combined with all the elements of second list one by one. Here is the process view.

First element of list “WordL1” is “Word11”. “Word11” is combined with each element of “WordL2” to produce the following text/terms.

Word11 Word21
Word11 Word22
Word11 Word23
.
.
.
Word11 Word2N

After the combination of first element of first list “WordL1” with each element of “WordL2”, second element of first list is picked and is combined with each element of second list in the same way. Here below is the process mechanism.

Word12 Word21
Word12 Word22
Word12 Word23
.
.
.
Word12 Word2N

In the similar fashion this process is continued until all the elements of “WordL1” are combined with “WordL2” to produce the output as described in Table 2.

Table 2. shows the text generated in rows after combining “WordL1” and “WorldL2”: the word in brackets () shows the table name and is not part of rows.

TABLE 2

Word11 Word21
Word11 Word22
Word11 Word23
.
.
.
Word11 Word2N
Word12 Word21
Word12 Word22
Word12 Word23
.
.
.
Word12 Word2N
Word13 Word21
Word13 Word22
Word13 Word23
.
.
.
Word13 Word2N
Word1N Word21
Word1N Word22
Word1N Word23
.
.
.
Word1N Word2N

The lists “WordL1” and “WordL2” are combined and a new list is generated as shown in the above Table 2. Let's call the combined list as “NewList”. The “NewList” is stored in temporary storage such as “Temp” Now this “Temp” is combined with next list in the queue i.e. “WordL3”. After combing “Temp” and “WordL3” is again called as “NewList”. The “Temp” is replaced with “NewList”. “Temp” is again combined with the next list in the queue and this process is continued until all the lists have been processed to produce the final output of the process. The final output of the process is “Temp”

The above mentioned process can be simply simulated through simple example as described below.

For example, let's consider a simple sentence “A1 A2 A3 AN”. Each word produces the following lists. The words in brackets ( ) are list headers and are not part of data in lists.

| (A1) | (A2) | (A3) | (AN) |
|---|---|---|---|
| A11 | A21 | A31 | AN1 |
| | A22 | A32 | AN2 |
| | A23 | | |

Total text generated=12 lines of text

The process generates the following text based on above lists. Generated text is divided into line with numbering from 1 to 12.
1. A11 A21 A31 AN1
2. A11 A21 A31 AN2
3. A11 A21 A32 AN1
4. A11 A21 A32 AN2
5. A11 A22 A31 AN1
6. A11 A22 A31 AN2
7. A11 A22 A32 AN1
8. A11 A22 A32 AN2
9. A11 A23 A31 AN1
10. A11 A23 A32 AN2
11. A11 A23 A31 AN1
12. A11 A23 A32 AN2

1. A method to generate a plurality of sentences, the method comprising the steps of:
inputting the source text through an input device of the processor-based apparatus;
analyzing the source text and extracting words from the source;
generating a list of words in the same language for each word present in input source from attached repositories in particular language based on desired retrieval mechanism such as predefine lists, aliases, synonyms, related words and autonyms based on corresponding dictionaries and repositories.
displaying the lists generated in above step;
selecting a set of desired words from each list from the lists generated in generating a list step;
combining all the generated lists to generate sentences;
storing the generated sentences;
returning generated sentences to output device;
attached repositories means the source from where words for each word are brought according to retrieval mechanism such as documents, single databases or multiple databases . . . etc. The repositories may be resided locally or remotely means repositories may be on the same computer or device or on other computer or device.
desired retrieval mechanism means according to which words are retrieved to from a list such as selecting synonyms retrieval mechanism brings the synonyms from repository for the specific word.
Text means data in specific format. It may be single or multiple sentences, characters, words, numbers, formulae and expressions . . . etc sentences and text are used alternatively.
Alias means a unique name for accessing multiple lists. An alias can be created by combining multiple predefined lists thereby and all the entries are all the lists are accessed attached with a alias.
output device means the device, thereby the generated sentences are transferred to output device.
input device means a device capable of input data into method through electrical, mechanical or digital signals, thereby signals understandable for the method such as mouse, keyboard . . . etc

2. The method according to claim 1 wherein the combining all the step comprises the steps of:
selecting first word of first list from desired words and combining with each word from desired words of second list then selecting the second word from desired words of first list and generating sentences by combining it with each word from desired word of second list, repeating the process until each word present in desired words of first list is combined with each word present in desired words of second list and store these sentences into temporary list;
repeating the above step with all the words of temporary list and desired words of third list and so on until all the lists have been combined;

3. The method according to claim 2 wherein said method including following:
a method, process or mechanism to generate the same sentences as in claim 2

4. The method according to claim 3 wherein the generated sentences may be filtered automatically to remove duplicate sentences if desired.

5. The method according to claim 1 wherein said method including following:
re-selecting a set of desired words from desired lists from the lists generated in generating a list step in claim 1;
generating a list of words in the same language for each word present in set of desired words from attached repositories in particular language of input source based on,desired retrieval mechanism such as predefined lists, aliases, synonyms, related words and autonyms based on corresponding dictionaries and repositories.
displaying lists generated in above step;
attached repositories means the source from where words for each word are brought according to retrieval mechanism such as documents, single databases or multiple databases . . . etc
desired retrieval mechanism means according to which words are retrieved to from a list such as selecting synonyms retrieval mechanism brings the synonyms from repository for the specific word.
Alias means a unique name for accessing multiple lists. An alias can be created by combining multiple predefined lists thereby and all the entries are all the lists are accessed attached with a alias.

6. The method according to claim 1 wherein said method including following:
re-selecting a set of desired words from each list from the lists generated in generating a list step in claim 1;
filtering the generated sentences to generate sentences comprising desired words;
storing generated sentences;
returning the generated sentences to output device;
output device means the device, thereby the generated sentences are transferred to output device.

7. The method according to claim 1, wherein the desired retrieval mechanism is determined by inputting an option signal to select a desired retrieval mechanism from a group of mechanisms.
desired retrieval mechanism means according to which words are retrieved to from a list such as selecting synonyms retrieval mechanism brings the synonyms from repository for the specific word.

8. The method according to claim 1, wherein the desired words are determined by inputting an option signal to select a desired word from a group of words.

9. A method according to claim 1, wherein the sentences are generated in the same language according to the language of input sentences.

10. A method as claimed in claim 1, wherein the said method including:
exposing a method to accept input sentences from outside of the said method;

11. A method as claimed in claim 1, wherein the said method including:
an output method for exporting the generating sentences, thereby the generated sentences are transferred to the desired output device;
output device means the device, thereby the generated sentences are transferred to output device.

12. A service for generating the plurality of sentences from plurality of input sentences, said service including:
inputting the words or sentences into service, wherein each word or sentence having desired retrieval mechanism such as predefine lists, synonyms, related words and autonyms based on corresponding dictionaries and repositories.
analyzing the input source
generating a list of words from attached repositories in the same language for each word in particular language in input source based on desired retrieval mechanism such as predefine lists, aliases, synonyms, related words and autonyms based on corresponding dictionaries and repositories.
combining all the generated lists to generate sentences;
returning the generated sentences to output device;
input source means the collection of words or sentences that are fed into the service
attached repositories means the source from where words for each word are brought according to retrieval mechanism such as documents, single databases or multiple databases . . . etc Attached repositories may be at the
same location as service or may be resided remotely at other locations than service.
desired retrieval mechanism means according to which words are retrieved to from a list such as selecting synonyms retrieval mechanism brings the synonyms from repository for the specific word.
location means the computer or device where service resides
output device means the device, thereby the generated sentences are transferred to output device.
Alias means a unique name for accessing multiple lists. An alias can be created by combining multiple predefined lists thereby and all the entries are all the lists are accessed attached with a alias.

13. The service according to claim 12 wherein the combining all the step comprises the steps of:
selecting first word of first list and combining with each word of second list then selecting the second word of first list and generating sentences by combining it with each word in second list, repeating the process until each word of first list is combined with each word of second list and store these sentences into temporary list;
repeating the above step with temporary list and third list and so on until all the lists have been combined;
storing the generated sentences;

14. The service according to claim 13 wherein said service including following:
any method of combining the lists to get the same sentences as in claim 12

15. The service as claimed in claim 14, wherein said service can be embedded inside smart cards and chips

16. The service as claimed in claim 15, wherein the said service can be invoked through input device
input device means a device capable of input data into service through electrical, mechanical or digital signals, thereby signals understandable for the service such as mouse, keyboard . . . etc

17. The service as claimed in claim 16, wherein the said service can be hosted locally or remotely

18. The service as claimed in claim 17, wherein the said service can be started remotely through input device
input device means a device capable of input data into service through electrical, mechanical or digital signals, thereby signals understandable for the service such as mouse, keyboard . . . etc

19. The service as claimed in claim 18, wherein the current status of the service can be altered through input device
input device means a device capable of input data into service through electrical, mechanical or digital signals, thereby signals understandable for the service such as mouse, keyboard . . . etc
status means the current condition of the service such as running, stopped and paused.
